(19) United States
(12) Patent Application Publication
(10) Pub. No.: US 2013/0346270 A1
(43) Pub. Date: Dec. 26, 2013

(54) INTERNET-BASED METHOD OF AND SYSTEM FOR ENABLING THE FREEDOM TO EXERCISE MONETARY RIGHTS ASSOCIATED WITH MONEY BACKING FINANCIAL PRODUCTS IN THE FINANCIAL MARKETPLACE

(71) Applicant: Joseph H. Hardison, III, Darien, CT (US)

(72) Inventor: Joseph H. Hardison, III, Darien, CT (US)

(21) Appl. No.: 13/631,240

(22) Filed: Sep. 28, 2012

Related U.S. Application Data
(63) Continuation of application No. 12/987,255, filed on Jan. 10, 2011, now abandoned.
Application No. 12/987,255 is a continuation of application No. 11/328,433, filed on Jan. 9, 2006, now abandoned.

(51) Int. Cl. G06Q 40/00

(52) U.S. Cl. 705/35

(57) ABSTRACT

Internet-based method of and system for enabling the freedom to exercise monetary rights associated with money backing financial products in the financial marketplace, wherein the right to make demand transactions against the money (e.g. exercise the right to make purchases, and the right to make payments) can be transferred to a first party for use and exercise, while the right to earn interest on the money is retained by the owner of the money, so as to take advantage of better rates and yields. The method and system can support diverse kinds of financial products including: checking accounts, debit cards, stored value products, ATM products, and other financial accounts and products, which can be more productive by utilizing various iterations of the monetary right(s) transfer processes.

### RELATED CASES

The present application is a Continuation of co-pending application Ser. No 12/987,255, filed Jan. 10, 2011, which is a Continuation of application Ser. No. 11/328,433 filed Jan. 9, 2006, now abandoned, each of which is commonly owned by Interest Capturing Systems, LLC, and incorporated herein by reference as if fully set forth herein.

### BACKGROUND OF INVENTION

1. Field of Invention

The present invention relates to an Internet-based method of and system for, enabling the customers of banks, brokerage firms, insurers and other financial institutions the freedom to exercise the rights they possess as holders of money so that they can optimize the utility and value of their money in the global financial marketplace.

2. Brief Description of the State of Knowledge in the Art (NEW)

FIG. 1 is a schematic representation of the conventional “Uses of Money” where the “Specific Functions of Money” represent the general purposes of money in an economic framework. The “Specific Functions of Money” include all uses of money, from its inception to the present day, and define money's role in local, national and global economies; all economies using any form of money incorporate some and/or all of these functions in their use(s) of money.

FIGS. 2A and 2B, taken together, set forth a schematic representation illustrating, the various conventional uses of/for money in the marketplace, including, but not limited to: purchasing and paying for goods and services, investing, earning interest, lending, borrowing, storing as value, and gifting.

FIG. 3 is a schematic representation illustrating the flow of money associated with conventional money transfer systems utilized in both physical money transfers and electronic money transfers in the global financial system. Money is transferred to another institution(s) and, at the end of the transfer period, the money and any accrued interest are transferred back to the owner of the money and/or the owner's bank or other financial institution.

Owners of money have many options from which to choose when selecting a bank or other type of financial institution for depositing (and subsequently investing) their money. Traditionally, owners of money usually choose their “home” financial institution based on physical location and on an institution's presence in their local market. “Home” bank(s) or financial institution(s) are defined as a customer's regular bank(s) or institution(s) where the customer maintains checking, savings, money market, credit/debit card accounts, etc., are maintained. Owners of money who choose to utilize financial institutions via the Internet do so primarily due to the inherent convenience and, due to the lower fees and the higher rates/yields offered by such institutions.

Most financial institution customers assume (and rightfully so) that there is a tremendous amount of time and effort involved in first trying to ascertain where the opportunities exist to earn higher interest rates/yields on their money and, second, in actively transferring their money into and back out of those institutions' accounts and products to capture the higher rates offered. Several internet sites have aggregated financial information for consumers, with Bankrate.com (www.bankrate.com) being the most popular and oft-cited of these sites. Bankrate.com ranks financial institutions' on rates offered on/for various accounts and products (and on other criteria), and provides hyperlinks for, and toll-free phone numbers to, the listed institutions.

However, Bankrate.com does not offer any transactional capability leaving all of the actual transfer work to the consumer. Several of the banks and institutions offering the higher interest rates/yields, like ING Bank, will facilitate transfers from a consumer's “home” bank(s) or institution(s) into accounts/products that offer better rates/yields. However, these banks and institutions only facilitate transfers from, and back to, the “home” institution(s). Furthermore, there are time lags, ranging from a couple of days to longer, during which time the consumer is not earning interest on the transferred monies as they are deemed “in transit” and unavailable for use.

Recent evidence suggests that many financial institutions haven't been paying the appropriate (or advertised) rates on these accounts and products. (“Investors Get Shortchanged on Interest”, The Wall Street Journal, Feb. 15, 2005, p. D1 and “Savings: Sweep Yields Can Make You Weep”, Kiplinger's Personal Finance, May 2005, p.92).

Many recent articles have highlighted the problems financial institution customers encounter when seeking higher interest rates/yields on their money. The article “Wall Street Cuts Yields on Investors' Cash” (The Wall Street Journal, Aug. 31, 2005, p. D1) states, “In a development that hurts investors, brokerage firms are quietly moving their clients' cash from money market mutual funds—the traditional default option—into lower-yielding bank accounts.”

Many systems have been designed to address the problems associated with freely transferring money. These range from systems that facilitate simple transfers of cash between parties, to complex systems consisting or electronic money systems (EMS) designed to transfer money electronically. Systems like Electronic Funds Transfer (EFT) and the Automated ClearingHouse (ACH) help to facilitate funds transfers between financial institutions, as they transmit funds electronically. However these systems are also inefficient as there are time lags when an owner of money does not have access to the transferred money and, thus, misses an opportunity to earn interest on the transferred money.

In addition to the problems individuals, businesses and other entities encounter in finding (and securing) higher interest rates and yields in the financial marketplace, there are other shortcomings in the financial marketplace which are not currently being addressed.

Also, when consumers purchase stored value cards or products (gift cards, prepaid cards, etc.) the consumer effects payment to the seller of the stored value card at the time of purchase. However, many stored value cards are not utilized for long periods after they are purchased. Some are lost or forgotten, and many are simply never redeemed or are only partially redeemed. In all of these instances, the seller of a stored value card has use of the purchaser's money on which the seller can earn interest, even though the value stored on a card or other product may not be utilized for a long time or may never be fully utilized. Irrespective of the circumstances behind the delayed usage or under usage (to any degree) of a stored value product, the buyer is surrendering to the seller the ability to earn additional interest even though the value stored on may not be immediately (or never) utilized.

In view of all of the aforementioned shortcomings, deficiencies and inefficiencies that exist in the local, national and global financial marketplaces, there is still a great need in the art for an improved system and methods for solving the problem(s) of surrendered interest-capturing opportunities while avoiding the shortcomings and drawbacks of the prior art apparatus and methodologies heretofore known.

### Objects and Summary of the Invention

Accordingly, it is a primary object of the present invention to provide a method of and system for solving the inefficiencies of prior art financial systems, while avoiding the shortcomings and drawbacks of the prior art apparatus and methodologies.

Another object of the present invention is to achieve this objective by providing an Internet-based method of and system which inherently recognizes the separate and transferable rights associated with money (cash) ownership, thereby enabling the maximization of economic value that such personal property can support within society.

Another object of the present invention is to provide such an Internet-based method and system, wherein the rights that customers of banks, brokerage firms, insurers and other financial institutions possess as owners, holders (fiduciary), and borrowers of money are automatically unbundled (i.e. individually separated) and ready to be transferred to other institutions offering more attractive financial terms in an effort to optimize the utility and economic value of their money.

Another object of the present invention is to provide such an Internet-based method and system, wherein the customers of financial and, non-financial institutions are afforded the opportunity to freely transfer the rights they possess as owners, holders (fiduciary), and borrowers of money (e.g. the right to earn interest (R (β, $)), between various institutions and also within their own institutions, so as to take advantage of better rates and yields.

Another object of the present invention is to provide such an Internet-based method and system, wherein, in situations where other entities collect monies for future payments on behalf of an individual or business, the rightful owner of the money is able to benefit from the transfer and/or use of such monetary rights until such payments are effected.

Another object of the present invention is to provide such an Internet-based method and system, wherein in lieu of transferring actual monies, consumers have the ability to make transfers of the right to earn interest (R (β, $)) on their monies, which constitutes a transfer of the right to earn interest possessed by the owner, holder (fiduciary), or borrower of money without the actual transfer of the monies, and yet still receive all of the benefits and protections such as deposit insurance that accompany the rights to those monies.

Another object of the present invention is to provide such an Internet-based method and system, wherein any subset of the entire set of monetary rights {(α. . . ι, $)} possessed by an owner, holder or borrower of money, and all rights associated with money, can be transferred among institutions within a global financial marketplace, including: the right to invest, the right to earn interest, the right to use money as collateral, the right to use money as security (store of value), the right to make purchases, the right to make payments, the right to lend, the right to borrow and, the right to gift.

Another object of the present invention is to provide such an Internet-based method and system, wherein the various rights associated with money are recognized individually, unbundled and separated, and then transferred individually or in groups that comprise a fraction of the total bundle of rights and, that allow a holder of those rights to maximize their utility and thus the utility of money.

Another object of the present invention is to provide such an Internet-based method and system, wherein the set of rights associated with money (R (α. . . ι, $)) possessed by a holder of money, are separate and divisible, and such individual rights can be more fully utilized in separate form such that the system user derives greater utility from money.

Another object of the present invention is to provide such an Internet-based method and system, wherein the set of rights possessed by a holder of money can be utilized in non-mutually exclusive manners and, by not precluding other associated rights, allows a system user to fully maximize the use of monies held.

Another object of the present invention is to provide such an Internet- based method and system, wherein one (or more) of the rights associated with holding money can be transferred by a system user, while simultaneously allowing the system user to derive the associated benefits and uses from the remaining rights that have not been transferred, thereby permitting some of the rights of money that have been transferred to be reduced or cancelled while/when certain other rights are being exercised.

Another object of the present invention is to provide such an Internet-based method and system, wherein a system user is allowed to automatically transfer various rights associated with money whereby a system user provides pre-selected investment criteria, objectives and instructions, and the system effects transfers accordingly.

Another object of the present invention is to provide such an Internet-based method and system, wherein all participating institutions (financial and non-financial) are allowed to provide information concerning interest rates, yields and other information about accounts and products offered directly to the system of the invention's database for ranking, and other, purposes in order to better inform users of the system about all potential transfer opportunities.

Another object of the present invention is to provide such an Internet-based method and system, wherein all participating institutions feed, directly, interest rate, yield, and other product information into a database maintained by the system, for the purpose of allowing the system of the invention to recommend certain accounts and products to users of the system.

Another object of the present invention is to provide such an Internet-based method and system, wherein a process allows the system to rank various accounts and products for a system user's benefit under criteria that may differ vastly from that employed by a system user.

Another object of the present invention is to provide such an Internet-based method and system, wherein a system user has the ability to program the system to make automatic transfers of one or more of the monetary rights associated with owned, held or borrowed money based on pre-specified criteria provided by the system user.

Another object of the present invention is to provide such an Internet-based method and system, wherein under such a scenario, the system user can rank the aforementioned criteria in order of importance, and the system and methods of the invention would make automatic monetary right(s) transfers on the user's behalf whenever the pre-specified criteria are met, thereby allowing a system user to set all of the parameters of a right(s) transfer and then allow the system to make such transfer automatically.

Another object of the present invention is to provide such an Internet-based method and system, wherein a system user can automatically reduce or cancel transfers of monetary right(s) in a one-step process.

Another object of the present invention is to provide such an Internet-based method and system, wherein its users can effect demand transactions on accounts at their “home” bank(s) while simultaneously transferring the right to earn interest on those monies backing the demand transactions, i.e. by reducing or canceling the transferred monetary right(s) to earn interest commensurate with the amount of any demand transaction, thereby allowing the user to maximize the utility of money held. Such transactions include those involving a debit card, any transaction involving a checking account, ATM withdrawal transactions, physical withdrawals transactions, and any and all other demand transactions.

Another object of the present invention is to provide such an Internet-based method and system, wherein full tax documentation is provided to a system user regarding any interest earned via the transference of the right to earn interest on monies held.

Another object of the present invention is to provide such an Internet-based method and system, wherein system users can earn interest on their monies held by other intermediaries that might hold the system user's monies in order to make future payments on the user's behalf.

Another object of the present invention is to provide such an Internet-based method and system, wherein at the time a payment is made on a system user's behalf, the amount of the transferred right to earn interest is reduced or cancelled commensurately, thereby assuring that the actual monies always stay with the payor and, that the interest earned on these monies accrues to the legal owner of those monies. Another object of the present invention is to provide such an Internet-based method and system, wherein consumers, businesses and all financial system participants are afforded the opportunity to transfer one or more monetary rights associated with holding money (R (α. . . ι, $)), via their demand deposits, time deposits, and other monies held as cash or in investment accounts at their “home” bank(s) or financial institution(s), to other institutions for the purpose of earning higher interests rates on their monies.

Another object of the present invention is to provide such an Internet-based method and system, wherein consumers, businesses and other parties (charities, government entities, trusts, pension funds, investment funds, individual retirement accounts (IRA's), church organizations, insurers, brokerage firms, banks, savings and loans, educational institutions, etc.) are given a way of and means for unbundling the monetary rights associated with holding money (R (α. . . ι, $)).

Another object of the present invention is to provide such an Internet based method and system, wherein government entities are provided with a “window” to monitor the transfers of the monetary right to earn interest (R (β, $)) within the system to prevent any type of illicit transfers, money laundering or terrorist funding activities.

Another object of the present invention is to provide such an Internet-based method and system, that obviates the need for an actual recall/transfer back of needed funds, as the actual funds, less any transferred monetary right(s), are already held by the “home” institution.

Another object of the present invention is to provide such an Internet-based method and system, wherein consumers and businesses have the ability to earn interest on monies paid into escrow accounts.

Another object of the present invention is to provide individual products, to users/accountholders within the MRTS Network, which utilize the various monetary right(s) transfer processes described herein. Examples would include: checking accounts, debit and credit cards, stored value products, ATM products, and other financial accounts and products, which can be more productive by utilizing (or embedding) various iterations of the monetary right(s) transfer processes.

These and other objects of the present invention will become more apparent from the descriptions and drawings contained herein, and are, by no means, confined or limited by other improvements or advantages that may he realized.

### BRIEF DESCRIPTION OF THE DRAWINGS

In order to understand more fully the Objects of the Invention, the following Detailed Description of the Illustrative Embodiments should be read in conjunction with the appended figure drawings, wherein:

FIG. 1 is a schematic representation of the conventional “Uses of Money” where the “Specific Functions of Money” represent the general purposes of money in an economic framework, while the “Set of Rights Possessed by a Holder of Money” represents the different rights or uses attendant with holding money;

FIG. 2A and 2B, taken together, set forth a schematic representation illustrating the various uses money in the marketplace, including purchasing and paying for products and services, lending, borrowing, and gifting;

FIG. 2C is a tabular representation of the gross discrepancies that exist between the highest interest rates and the average interest rates for the same accounts and products on a nationwide basis;

FIG. 3 is a schematic representation illustrating the flow of money associated with conventional money transfer systems, wherein at the end of the transfer period, principle money and accrued interest are transferred back to owner of money, or its bank;

FIGS. 4A and 4B, taken together, set forth a set of equations that formally recognize and describe that a broad set of monetary rights possessed by an owner of money can be separated into individual rights (R (α. . . ι, $)) in accordance with the principles of the present invention, and illustrating that, in accordance with the principles of the present invention, this set of individual rights is divisible, and each individual right is separately transferable, in a non-mutually exclusive manner, so as to maximize the utility of money in the global marketplace, in a manner akin to the bundle of rights possessed through ownership of land, including rights pertaining to minerals, timber, agriculture, riparian rights, surface and ground water, air, and development, to name the most common rights here;

FIG. 5 is a schematic representation of the money rights transfer (MTS) process carried out by the Internet-based Monetary Rights Transfer System (MRTS) Network of the present invention, wherein, in this illustrative embodiment, only the right to earn interest (R (β, $)) possessed by an owner of money is transferred from a “home” financial institution to either an “external” institution(s) or internally within the “home” institution's accounts and products, while all other monetary rights within the bundle {R(α. . . ι} possessed by the holder of money remain at the “home” institution for full use by the holder, thereby allowing the holder to maximize the utility of the money held in the global marketplace, accordance with the principles of the present invention;

FIG. 6 is a schematic representation of the Internet-based MRTS Network of the present invention, showing its various components interacting so as to enable a system-user (i.e. account holder) to transfer one (or more) of the individual rights (in this representation the right to earn interest (R (β, $))) associated with money ownership (whether owned outright, held in a fiduciary capacity, or borrowed) to one or more participating institutions that feed (to the MRTS's information servers) information on interest rates/yields, accounts and products, and other information relevant to helping a system user make investment decisions with regard to right(s) transfers;

FIG. 7A is a high-level systems block diagram representation of the Internet-based MRTS Network of the present invention, realized as an industrial-strength, carrier-class, globally-extensive packet-switched financial information management and communications network, designed and implemented as an object-oriented system on a Java-based object-oriented integrated development environment (IDE) such as, for example, WebObjects 5.2 IDE by Apple Computer Inc, Websphere IDE by IBM, or Weblogic IDE by BEA, or the Microsoft® Visual Studio 2005 .NET IDE;

FIGS. 7B1 and 7B2 are schematic representations of two alternative implementations of the enterprise-level MRTS Network of the present invention using Apple's WebObjects™ and its Java Application Server as an exemplary systems deployment environment;

FIG. 8A is an exemplary chart describing various kinds of Accountholder Services that can be supported on the MRTS Network of the present invention;

FIG. 8B is an exemplary list of the potential users/accountholders on the MRTS Network of the present invention;

FIG. 8C is exemplary list describing the diverse provisions which the MRTS Network of the present invention seeks to provide to all its users/accountholders;

FIG. 9 is a schematic representation depicting a systems-level architecture of the various services supported by the MRTS Network of the present invention, including (i) management services for financial institutions who have registered with the MRTS Network, interest-capturing products and services offered to clients over the MRTS Network, as well as (ii) management services for clients holding accounts on interest capturing products and services, registered on and supported by the MRTS Network;

FIG. 10 is a schematic representation depicting the various management services supported for any financial product registered and offered on the MRTS Network of the present invention, including financial institution configuration and maintenance, consumer metrics, continual interest rates and product/account updates, provide deposit and account insurance;

FIGS. 11 A through 11C2, taken together, set forth a schematic representation of a Commerce-Enabling Right To Earn Interest (REI) Transfer Process supported on the MRTS Network of the present invention, wherein a user/accountholder's monetary right to earn interest (R (β, $)) is transferred in a time-coincident manner with his/her exercise of the right to make purchases (R (ε, $)) (via his/her right to make payments (R (φ, $) and the right to make withdrawals (e.g. hold money as a store of value) (R (δ, $)), specifically, a user/accountholder transfers R (β, $) in order to earn higher interest rates/yields but, as the user utilizes other, non-mutually exclusive rights associated with holding money through demand account transactions (e.g. R (ε, $)), (R (φ, $)), and (R (δ, $)), the amount of R (β, $) is automatically reduced or cancelled commensurately, thereby allowing a user to maximize the utility and value of money held;/owed;

FIG. 12 is a flow chart depicting the various steps carried out by the Commerce-Enabling REI Transfer Process shown in FIGS. 11A through 11C2, allowing a system user/accountholder to both transfer the right to earn interest R (β, $) and, at the same time, conduct commerce by utilizing other, separable rights associated with money ownership;

FIG. 13 is a schematic representation of an exemplary Accountholder Information Collection and Storage form that can be used by the MRTS Network of the present invention, in order to collect and store relevant information relating to the opening and maintenance of an account on the MRTS Network of the present invention;

FIG. 14 is a schematic representation of an exemplary Accountholder Preference Collection and Storage form that can be used by the MRTS Network to allow an accountholder to supply account data to the system, rank display and transfer criteria, and provide institution and/or account/product data for the accountholder's Preferred Partner Network (PPN) maintained on the MRTS Network;

FIG. 15 is a schematic representation of the Tax Recognition and Reporting Process supported by the MRTS Network of the present invention, whereby the MRTS Network automatically coordinates the collection and distribution of information pertaining to taxable interest earned by users on the MRTS Network; and

FIG. 16 is a flow chart describing the various steps involved in the Tax Recognition and Reporting Process depicted in FIG. 15.

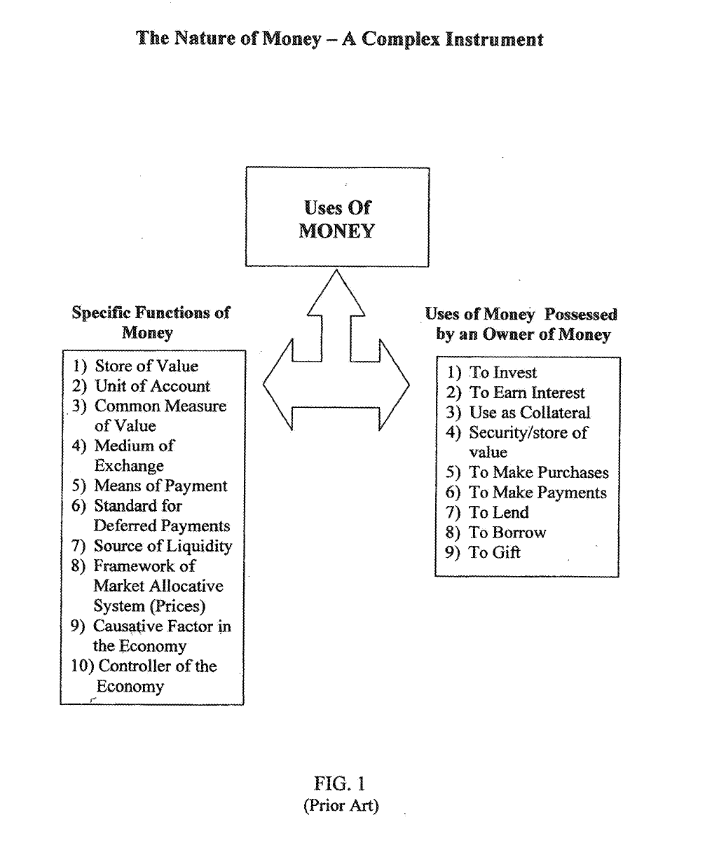

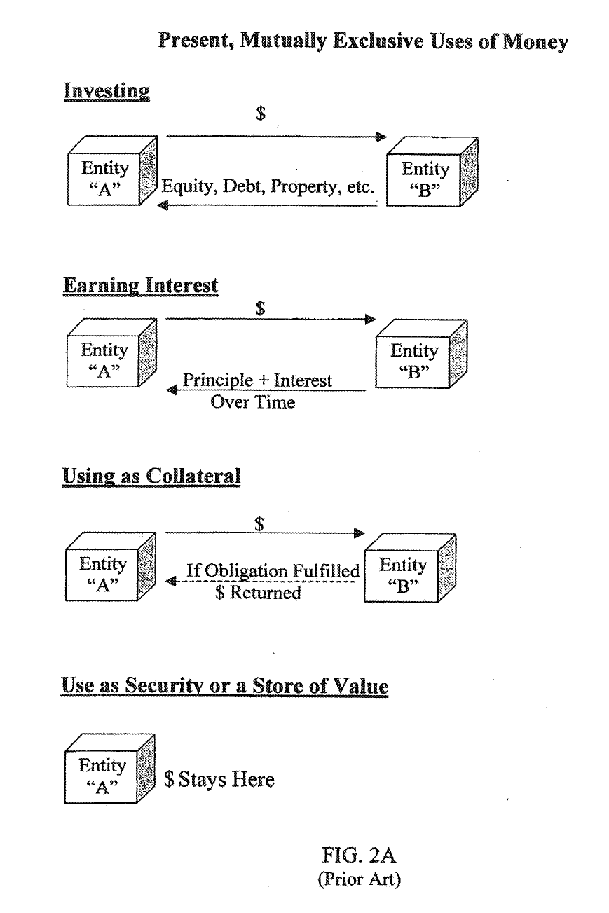

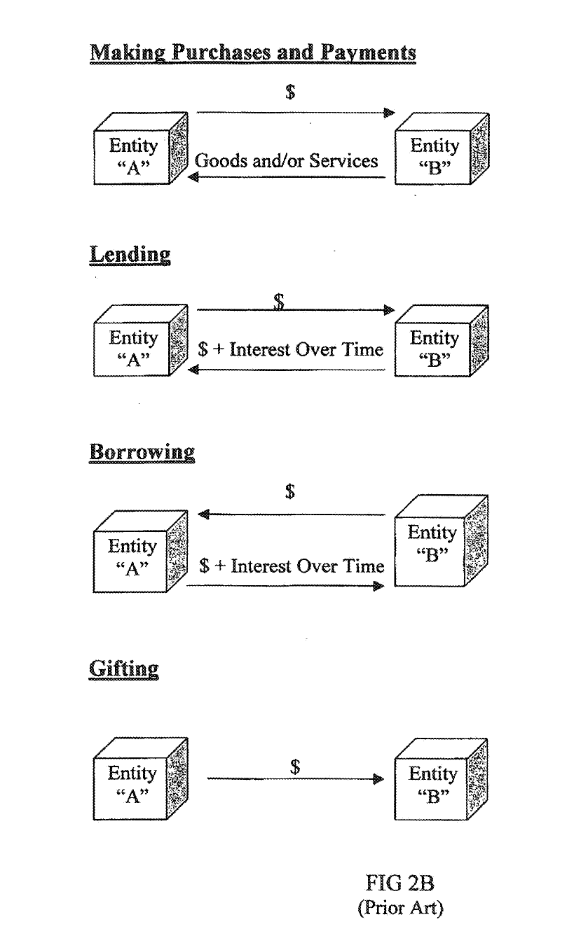

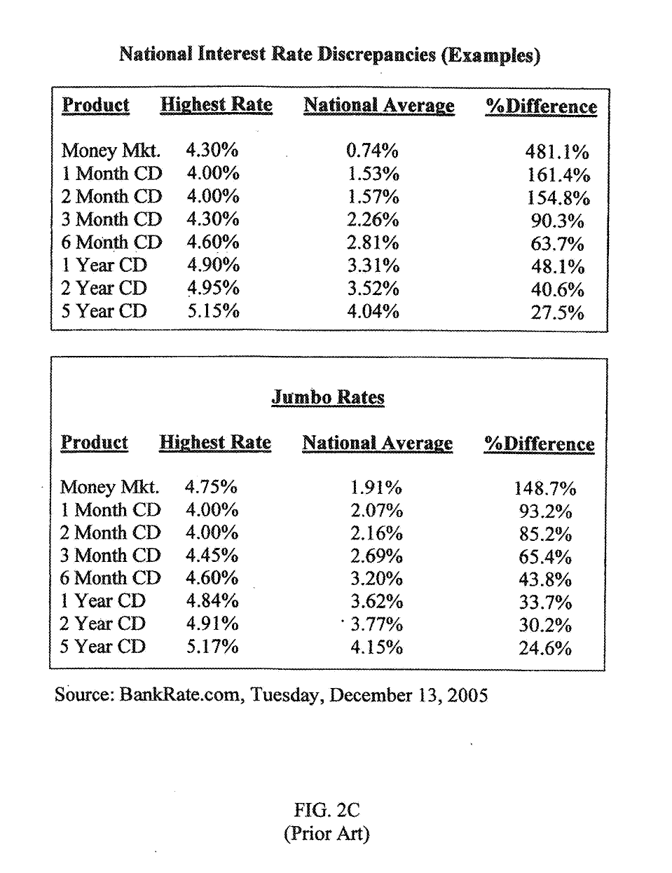

### DETAILED DESCRIPTION OF ILLUSTRATIVE EMBODIMENTS OF THE PRESENT INVENTION

Referring now to the figures in the accompanying Drawings, the illustrative embodiments of the present invention will now be described in great technical detail, wherein like parts are indicated by like reference numbers.

Overview of the Method of Monetary Rights Transfer According to the Principles of the Present Invention

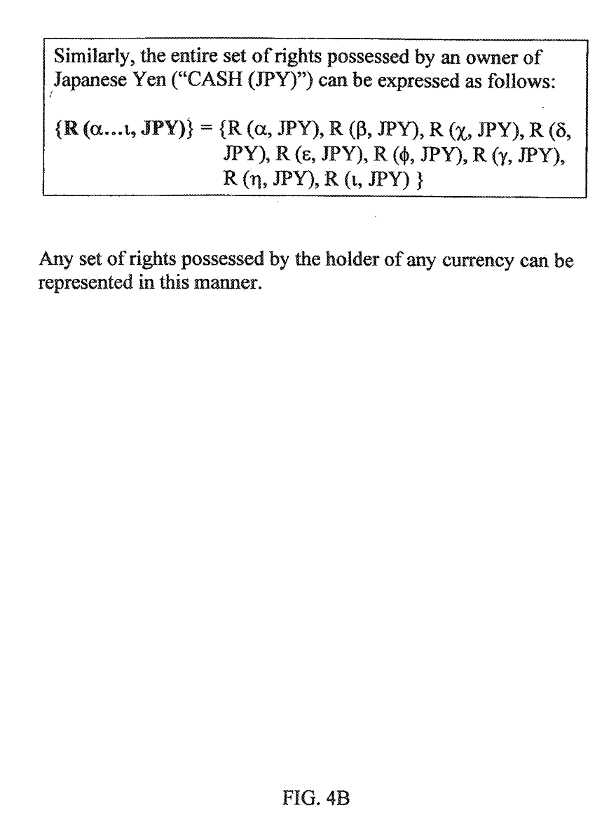

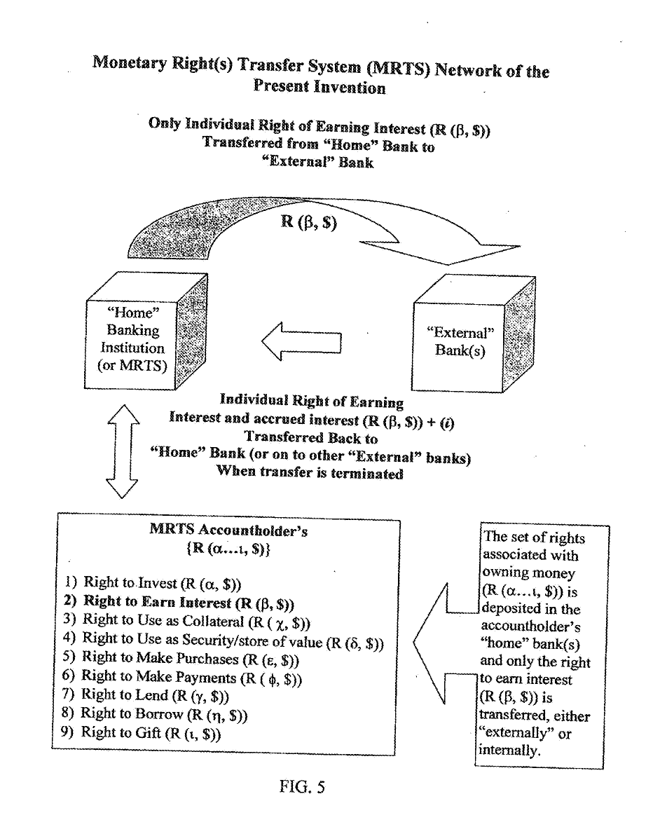

Referring to FIGS. 4A and 4B, there is presented an important set of equations that formally recognizes a broad set of monetary rights, possessed by an owner of any amount of money (i.e. funds), that can be separated into individual rights (R (α. . . ι, $)) and effectively transferred in the marketplace in accordance with the principles of the present invention. As will be described in great detail hereinafter, the transfer of such monetary rights is carried out using the Internet-based Monetary Rights Transfer System (MRTS) Network of the present invention which recognizes and ensures that the above-identified set of individual rights is divisible, and each individual right is separately transferable on the MRTS Network, in a non-mutually exclusive manner, so as to maximize the utility and value of money in the global marketplace. Such divisibility of rights is akin to the bundle of rights possessed through ownership of land, including rights pertaining to minerals, timber, agriculture, riparian rights, surface and ground water, air, and development, to name the most common rights.

Overview of Internet-based MRTS Network of the Present Invention

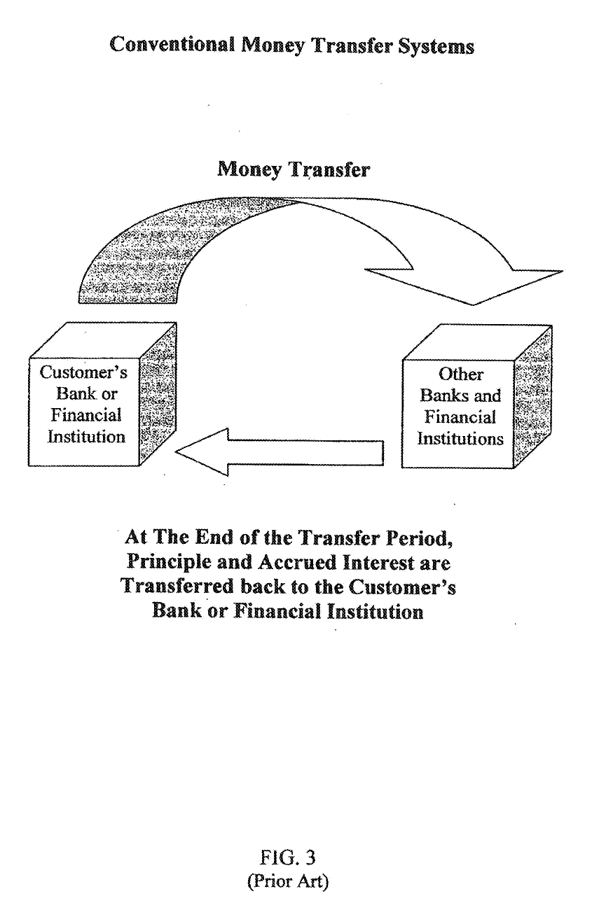

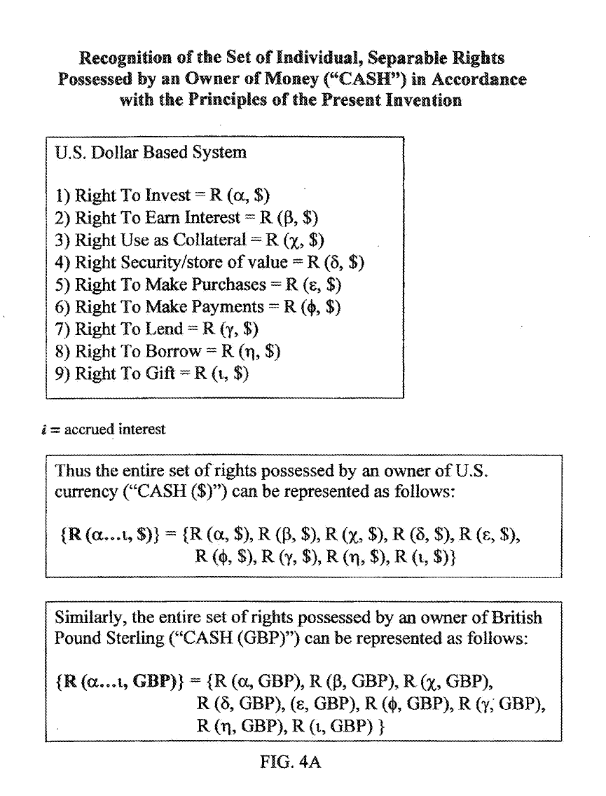

As shown in FIG. 5, the Internet-based MRTS Network of the present invention, represents a significant improvement on the “Conventional Money Transfer Systems” as illustrated in FIG. 3. In this figure, the MRTS Network is shown transferring only the right to earn interest (R (β, $)) possessed by an owner of money, from a “home” financial institution to either an “external” institution(s) or internally within the “home” institution's accounts and products, in order to allow the owner to receive better rate(s)/yield(s) at an “external” institution than that offered at the owner's “home” institution. while all other monetary rights within the bundle {R(α. . . ι)} possessed by the holder of money remain at the “home” institution for full use by the holder, thereby allowing the holder to maximize the utility of the money held in the global marketplace, accordance with the principles of the present invention. For the purpose of the present invention, an “external” bank(s) or financial institution(s) is defined as any other bank or financial institution to which a user of the MRTS Network and methods described herein, might transfer monies and investments, either manually or automatically and, either through an actual transfer of a user's monies or investments or through a transfer of the user's monetary right to earn interest which constitutes a transfer of the right to earn interest associated with a user's monies and investments, but not the user's actual monies and/or investments.

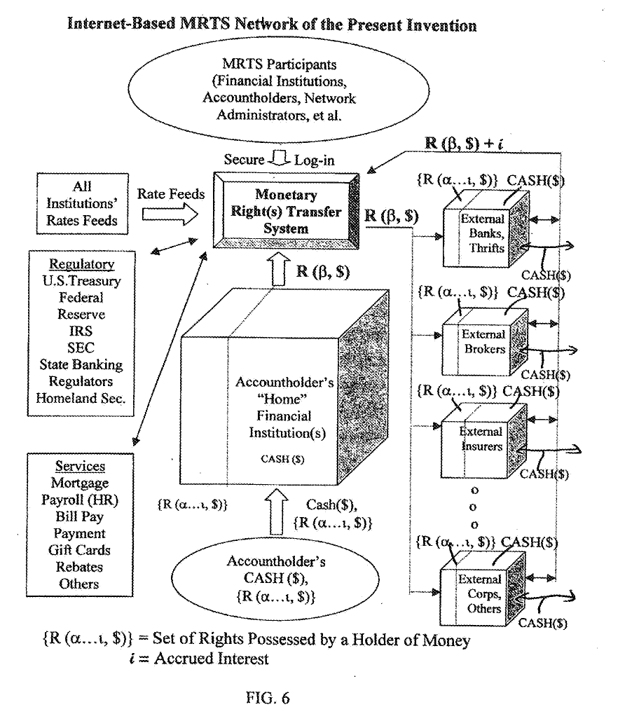

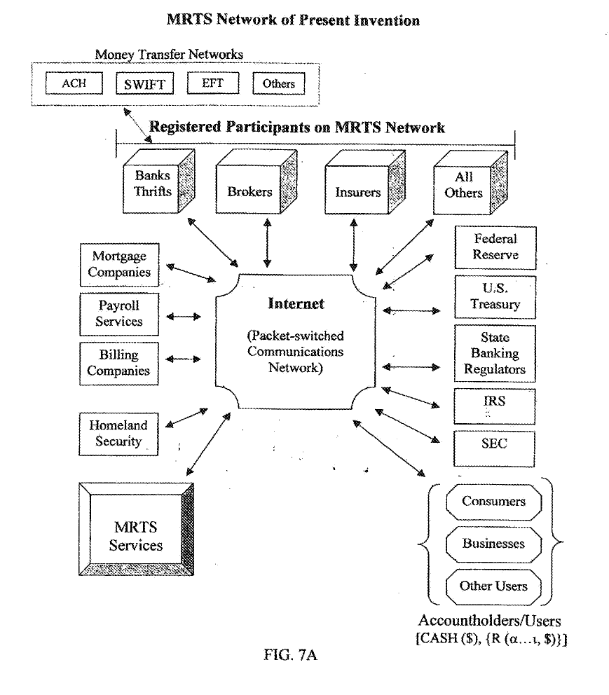

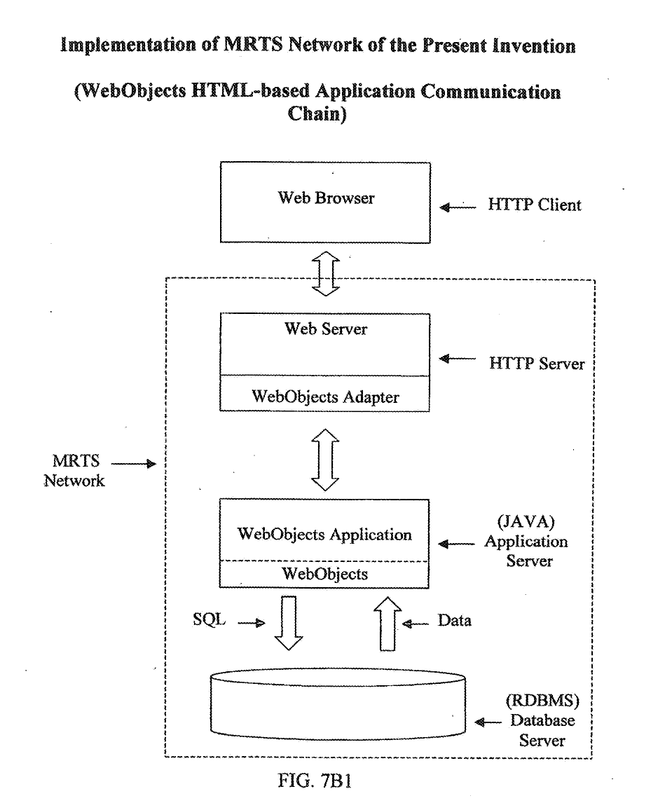

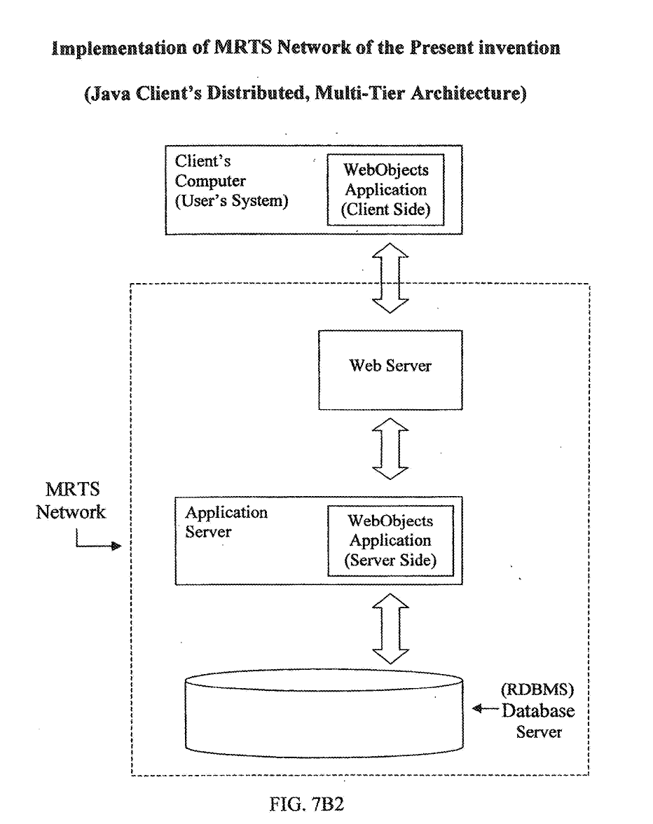

As shown in FIG. 6, the Internet-based MRTS Network of the present invention is shown comprising various enterprise-level information systems and supporting global financial information services, for each financial institution registered as a participating member of its MRTS Network (e.g. Banks. Thrifts, Brokers, Insurers, Mortgage companies, Payroll services companies, Billing companies, and other institutions including Homeland Security, Federal Reserve, US Treasury, State Banking Regulators, IRS, SEC, et al). As shown, each of these enterprise-level information management and transaction supporting systems is integrated with the information infrastructure and services of the MRTS Network, including its web, application and database servers (FIGS. 7B1 and 7B2) configured according to a multi-tier network architecture supported with packet-switched firewall, switch and router technology well known in the networking communications art.

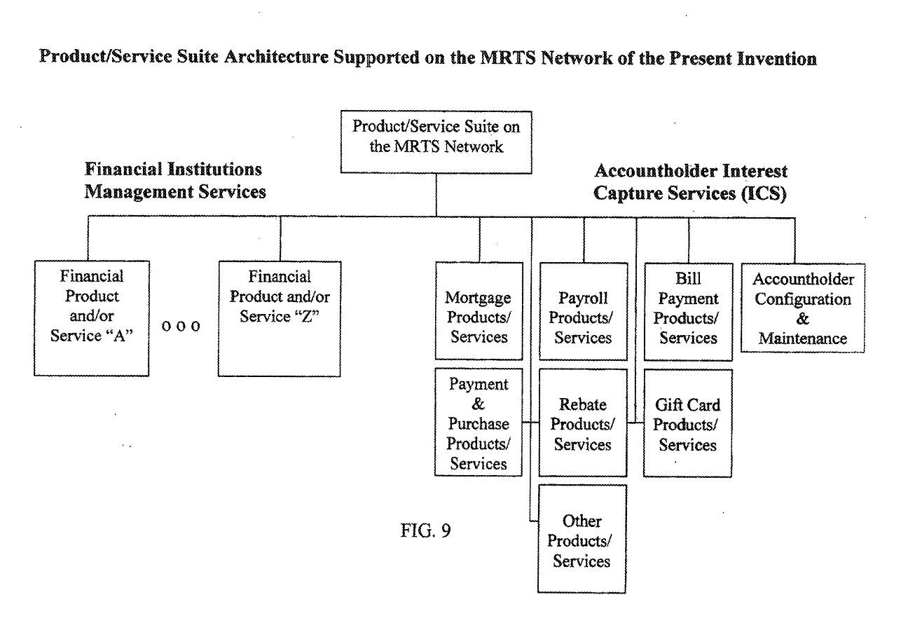

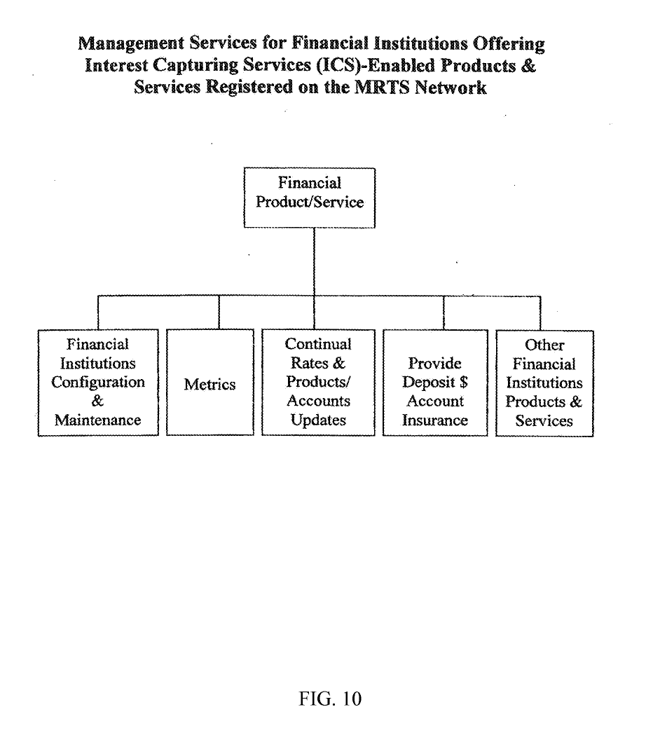

As will be described in greater detail hereinafter, web, application and database servers at each node in the MRTS Network cooperate so as to support and deliver the various suites of information services on the MRTS Network, depicted in FIG. 9 through 10. Among such services are the interest-capturing service (ICS) of the present invention, wherein a system-user (i.e. account holder) is capable of transferring one (or more) of his or her monetary rights (i.e.

the right to earn interest (R (β, $)) associated with money ownership) to one or more participating financial institutions registered on the MRTS Network. As will be described in greater detail hereinafter, this service involves each financial institution registered on the MRTS Network, and offering a ICS-enabled financial product or service, to automatically feed (to the MRTS Network's information servers) various kinds of time-varying information relating to interest rates/yields, accounts and products, and other information relevant to helping a system user make investment decisions with regard to interest right(s) transfers.

As illustrated in FIG. 6, an owner of money that has established an account(s) within a “home” bank(s) is also an MRTS accountholder. As shown, the MRTS servers (which are mirrored at various locations around the globe) receives, via the Internet's IP infrastructure, rate/yield, account/product, and other information fed to the MRTS's databases by all participating financial institutions. At the end of the R (β, $) transfer period, which may be determined by the accountholder or by the MRTS Network, the accountholder's R (β, $) +/− (i) may then be either returned to the MRTS servers. Even if the accountholder chooses to transfer the R (β, $) to another institution, the accountholder can choose to transfer the accrued interest (i) along with the R (β, $) back to the MRTS accountholder's account(s) at the “home” institution. At the end of the monetary right(s) transfer process R (β, $)+(i) is returned to the MRTS accountholder's accounts) at the accountholder's “home” institution.

Implementation of the MRTS Network of the Present invention

As shown in FIGS. 7A, the MRTS Network of the present invention is preferably designed and implemented as an industrial-strength, carrier-class Internet-based financial information communications network of object-oriented system engineering (OOSE) design. Using available object-oriented technology, this system can be developed in various ways: for example, using any suitable Java-based object-oriented integrated development environment (IDE) e.g. WebObjects 5.2 by Apple Computer Inc, Websphere IDE by IBM, or Weblogic IDE by BEA; or using another object-oriented programming language such as C sharp, supported by the Microsoft® Visual Studio 2005 .NET IDE. FIGS. 7B1 and 7B2 show two alternative implementations of the enterprise-level MRTS Network of the present invention using the WebObjects IDE and Java Application Server.

Overview of the Services Supported on the MRTS Network of the Present Invention

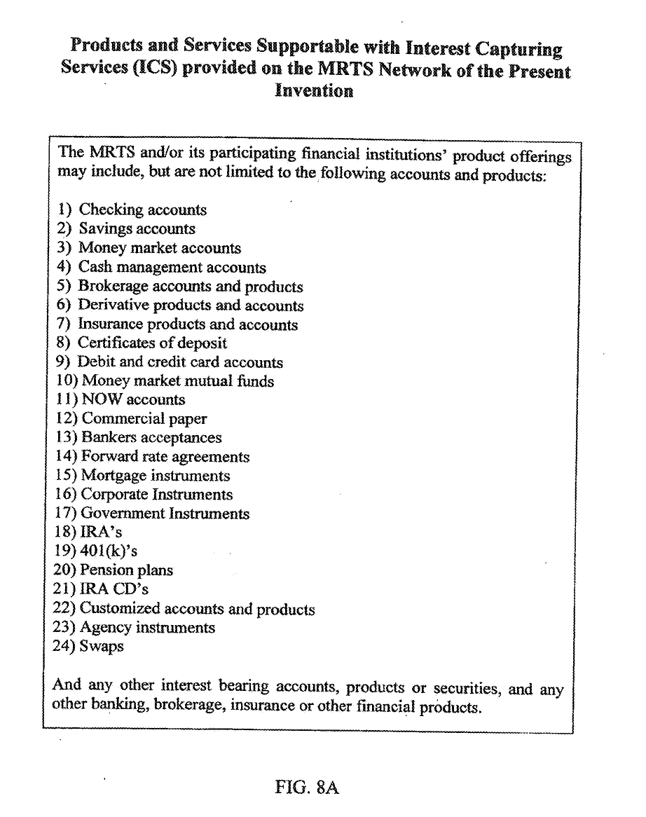

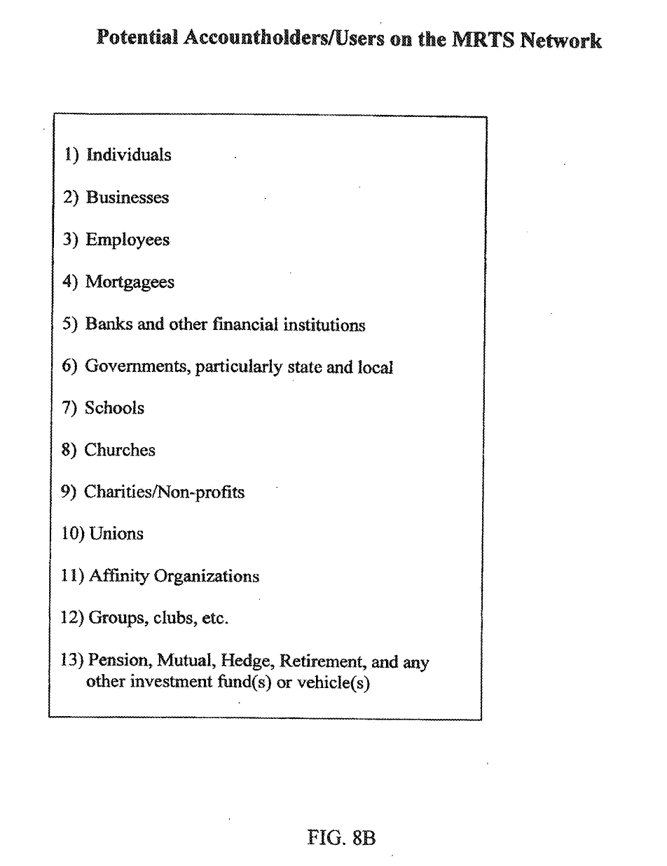

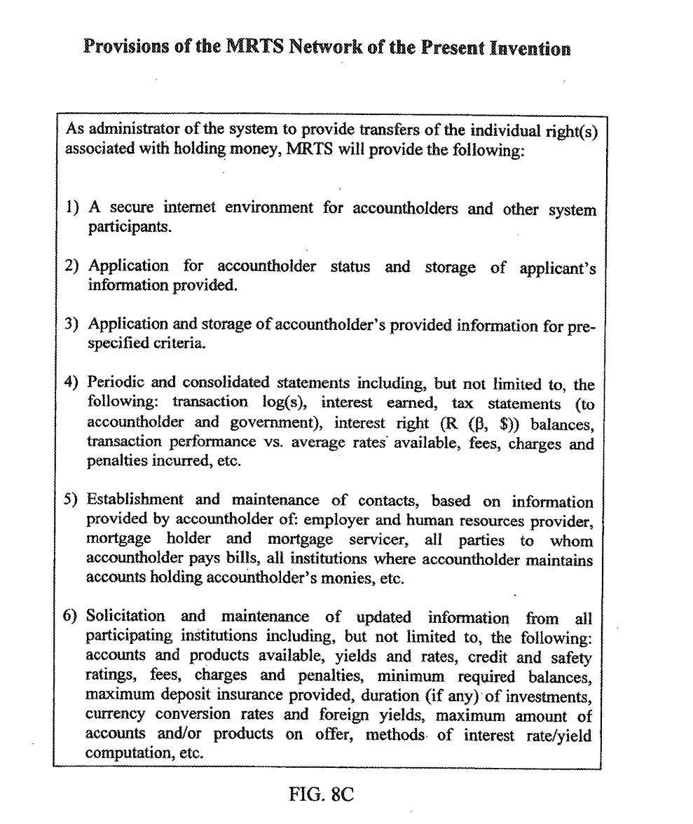

FIG. 8A is an exemplary chart describing various kinds of Accountholder Services that can be supported on the MRTS Network of the present invention. This list is representative of the many kinds of the accounts and products that various participating institutions (including the MRTS Network administrator) may offer on MRTS Network to accountholders. FIG. 8B provides an exemplary list of the potential users/accountholders on the MRTS Network of the present invention. Notably, many of these listed users have implicit/explicit fiduciary responsibilities to their clients, requiring them to obtain the best possible terms for their accountholders/customers, which is one of the primary goals of the MRTS Network. FIG. 8C describes the diverse provisions which the MRTS Network of the present invention seeks to provide to all its users/accountholders.

As shown in FIG. 9, the MRTS Network of the present invention supports and delivers various financial information and accounting services to both its institutional members as well as its accountholders, namely: (i) management services for financial institutions who have registered and are supporting their “interest-capturing” products and services on the MRTS Network; as well as (ii) management services for clients holding accounts on “interest capturing” products and services, registered on and supported by the MRTS Network.

In FIG. 10, the various management services supported for any financial product offered on and registered with the MRTS Network of the present invention, are shown to include: financial institution configuration and maintenance; consumer metrics; continual interest rates and product/account updates; deposit and account insurance; etc. In FIG. 10, the various management services supported for any client financial account associated with a ICS-product/service registered on the MRTS Network, are shown to include: the client's right to initiate the transfer of his/her right to earn interest (REI); check all account balances; update user preferences; review updated rate feed information; as well as the various REI Transfer Methods supported on the MRTS Network of the present invention. Through the “Update user preferences services, an accountholder provides all relevant personal/business information including, but not limited to accountholder: name, address, city, state, zip code, country, email address, home phone, business phone, mobile phone, date of birth, employer, mortgage holder/servicer, human resource administrator, existing “home” accounts and products, passwords, etc. Additionally, an accountholder can establish, save and change preferences related to right(s) transfers. Such transfer preferences may include, but are not limited to, institutions, accounts, products, transfer methods, preferred partner networks (PPN), criteria by which institutions/accounts and products are ranked, criteria by which transfers are effected, etc. Through “Review Updated Rate Fee Information” Services, accountholders can also review updated rate feed information from all participating institutions, with the system databases constantly receiving, ranking and displaying all incoming data as it relates to rates/yields, accounts and products, institutions, expenses, etc. In addition to the basic REI Transfer Methods, there are additional services supported by the MTRS Network which allow an accountholder to transfer the monetary right to earn interest on monies owned by an accountholder until either transactions are effected by the accountholder, or by others effecting payments on behalf of the accountholder. These services will be described in greater detail hereinafter.

REI Transfer Process Coincident With Purchases, Payments, and Withdrawals (Commerce Facilitation) on The MRTS Network of the Present Invention

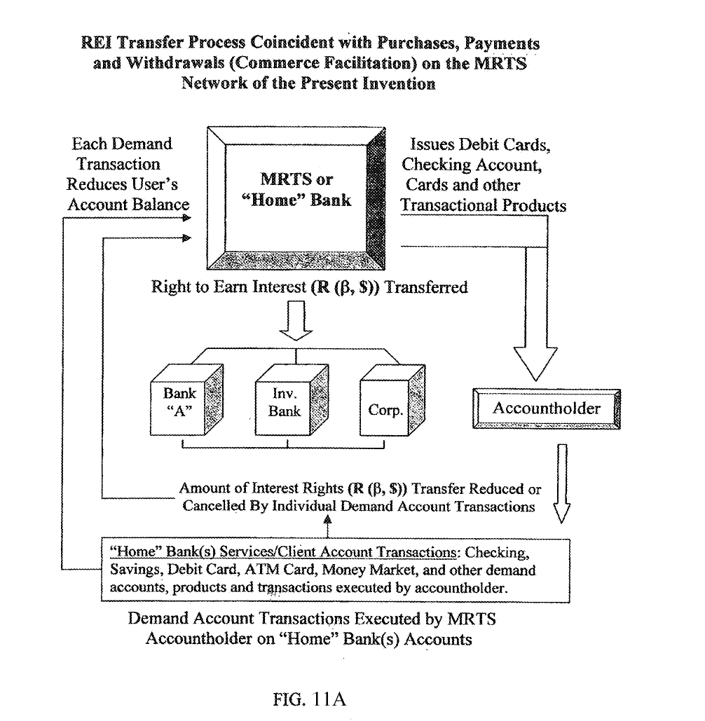

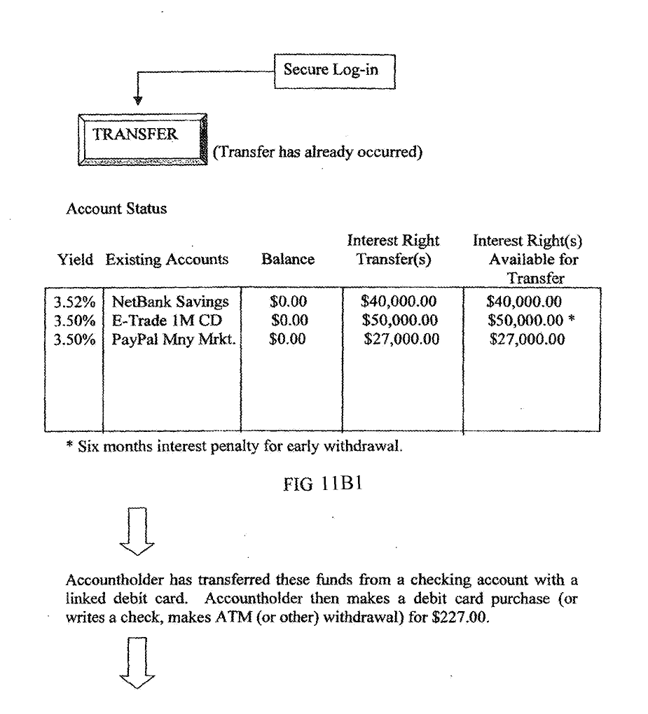

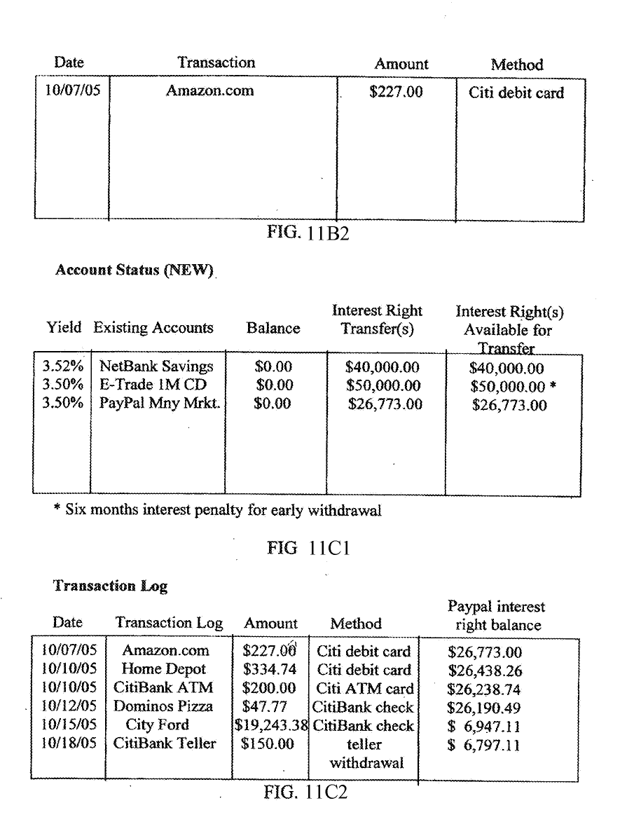

Referring to FIGS. 11A, 11B1, 11B2, 11C1, 11C2, 13 and 14, the REI Transfer Process Coincident with Purchases, Payments and Withdrawals (Commerce Facilitation) on the MRTS Network of the Present Invention, supported on the MRTS Network, will now be described in greater detail.

FIGS. 11A through 11C-3, taken together, set forth a schematic representation of the process supported by the MRTS Network of the present invention, for transferring of the monetary right to earn interest (R β, $)) coincident with user/accountholder's exercise of the right to make purchases (R (ε, $)) utilizing the right to make payments (R (φ, $) and the right to make withdrawals (hold money as a store of value) (R (δ, $)) wherein a system user/accountholder transfers R (ε, $) in order to earn higher interest rates/yields but, as the system user utilizes the other, non-mutually exclusive rights associated with holding money through demand account transactions (R (ε, $)), (R (φ, $)), and (R (δ, $)), the amount of R (β, $) is reduced or cancelled commensurately, thereby allowing a system user to maximize the utility of money held.

FIG. 11A-11C2 is one of the processes by which the system and methods of the invention allow an MRTS accountholder to maximize the utility of money owned by separating, and simultaneously utilizing, the individual, non-mutually exclusive, monetary rights (R (α. . . ι, $)) as defined in “Recognition of the Set of Rights Possessed by an Owner of Money in Accordance with the Principles of the Present Invention” (FIGS. 4A-B). In this process, the MRTS accountholder's “home” bank(s) (or the MRTS Network itself) issues demand accounts and products to the MRTS accountholder in the form of checking accounts, savings accounts, debit/credit cards, ATM cards and any and all other transactional products.

In FIG. 11A, the MRTS accountholder transfers the right to earn interest (R (β, $)) to any of the participating institutions in order to earn additional interest. During the course of normal, everyday commerce the MRTS accountholder utilizes one of the transactional products to make purchases, pay bills, withdraw funds, etc. from accounts/products maintained at the accountholder's “home” bank(s) or within the MRTS system. Coincident with the MRTS accountholder's use of a transactional product, the accountholder's transferred R (β, $) is reduced commensurately with the amount of the purchase(s) and/or payment(s).

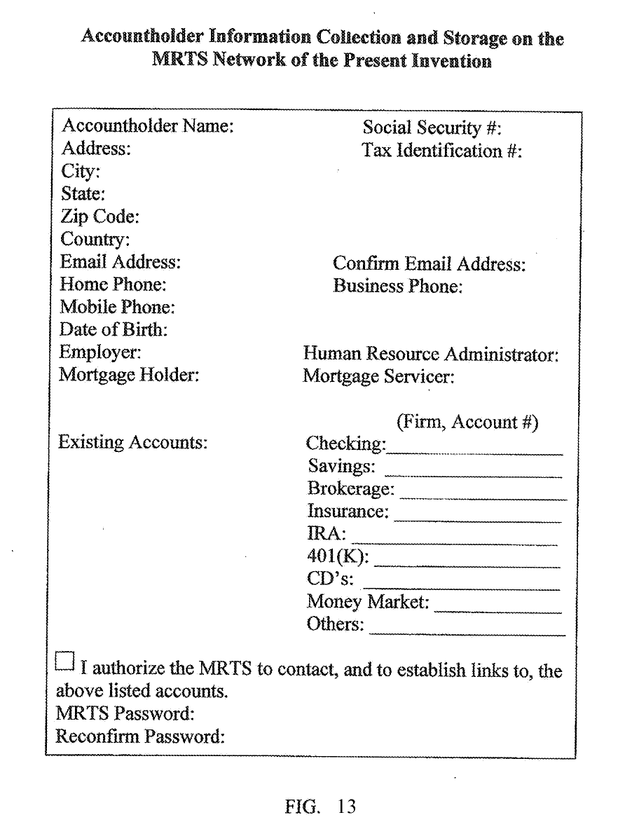

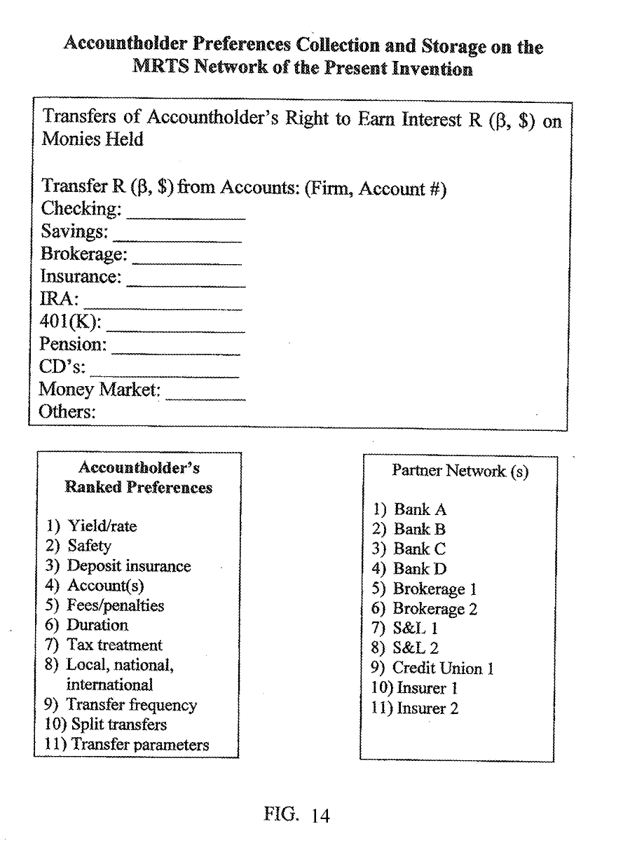

Now, referring to FIG. 11B1, the MRTS Network provides an MRTS accountholder with a screen showing all of the accountholder's R (β, $) transfers; such screen including the institutions and accounts/products to which the accountholder's R (β, $) has been transferred, the various account(s) balances, rate/yields, etc. Upon execution of a demand transaction (FIG. 11B2), an electronic signal is sent to the MRTS Network of the present invention, as the accountholder has previously provided sufficient “home” institution(s) account/product information (see FIGS. 13 and 14) to cause a “linking” of the demand account(s) to the accountholder's account(s) within the MRTS. Upon receiving the signal that a demand transaction has been effected, the MRTS Network automatically reduces or cancels the accountholder's transferred R (β, $) commensurate with the amount of the demand transaction. If the accountholder has multiple R (β, $) transfers, the MRTS will reduce or cancel the transferred R (β, $) in an account(s) based on the user's pre-specified transfer criteria. This process can be repeated multiple times in any time period.

All R (β, $) (or other right(s)) transfers, or transfer reductions or cancellations, will be reflected in the accountholder's “Accounts Status (NEW)” (FIG. 11C1), and includes a transactional log (FIG. 11C2) of all of the accountholder's MRTS transactional activities.

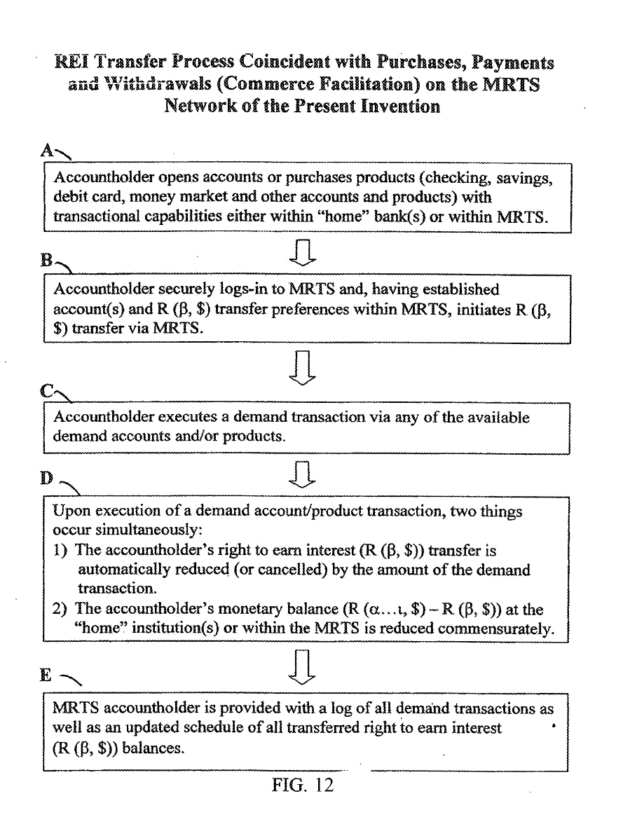

FIG. 12 is a flow chart depicting the various steps carried out by the Commerce Facilitation Process shown in FIGS. 11A through 11C2, allowing a system user/accountholder to both transfer the right to earn interest R (β, $) and, at the same time, conduct commerce by utilizing other, separable rights associated with money ownership.

Now referring to FIG. 12, at Block A, an MRTS Network accountholder opens accounts and/or purchases products (checking, savings, debit card, money market, stored value cards, gift cards, and other accounts and/or products with transactional capabilities, either within the “home” institution(s) or within the MRTS Network. At Block B, the MRTS accountholder securely logs-in to the MRTS Network and, having established account(s) and R (β, $) transfer preferences within the MRTS Network, initiates R (β, $) transfer(s) via the MRTS Network. At Block C, the MRTS accountholder executes a demand transaction via any of the available demand accounts and/or transactional products. At Block D, upon execution of a demand account/transactional product transaction, two things occur simultaneously: the MRTS accountholder's R (β, $) transfer is automatically reduced (or cancelled) commensurate with the amount of the demand transaction and, the MRTS accountholder's monetary balance (R (α. . . ι, $)−R (β, $)) in the demand account (or in the transactional product) at the “home” institution(s), or within the MRTS Network, is reduced commensurately by the amount of the demand transaction. The recipient of the demand transaction payment thus receives the entire set of monetary rights (R (α, . . . ι, $)) associated with money ownership. At Block E, the MRTS Network accountholder is provided with a log of all demand transactions as well as an updated schedule of all transferred right to earn interest (R (β, $)) balances.

GUI-Based Control Panels Enabling the Delivery of Services On the MRTS Network of the Present Invention

Having described the structure, function and operation of the MRTS Network of the illustrative embodiment, it is appropriate at this juncture to briefly describe some exemplary GUI-Based Control Panels that can be used to enable the delivery the services supported on the MRTS Network of the present invention.

FIG. 13 shows an exemplary Accountholder Information Collection and Storage form that can be used by the MRTS Network of the present invention, in order to collect and store relevant information relating to the opening and maintenance of an account on the MRTS Network of the present invention.

FIG. 14 shows an exemplary Accountholder Preferences Collection and Storage form that can be used by the MRTS Network to allow an accountholder to supply account data to the system, rank display and transfer criteria, and provide institution and/or account/product data for the accountholder's Preferred Partner Network (PPN). The first section of the form allows an accountholder to establish from which registered account(s)/product(s) to transfer the accountholder's R (β, $). The second part of the form allows an MRTS accountholder to rank the various R (β, $) transfer criteria that will be used in the aforementioned methods and their various iterations to transfer an accountholder's R (β, $). The final form allows an MRTS accountholder to establish Preferred Partner Network(s) that can specify to which institutions' accounts/products to transfer accountholder's R (β, $).

Tax Recognition and Reporting Processes Supported on the MRTS Network of the Present Invention

Referring to FIGS. 6, 7, 15 and 16, the Tax Recognition and Reporting Processes supported on the MRTS Network will now be described in greater detail.

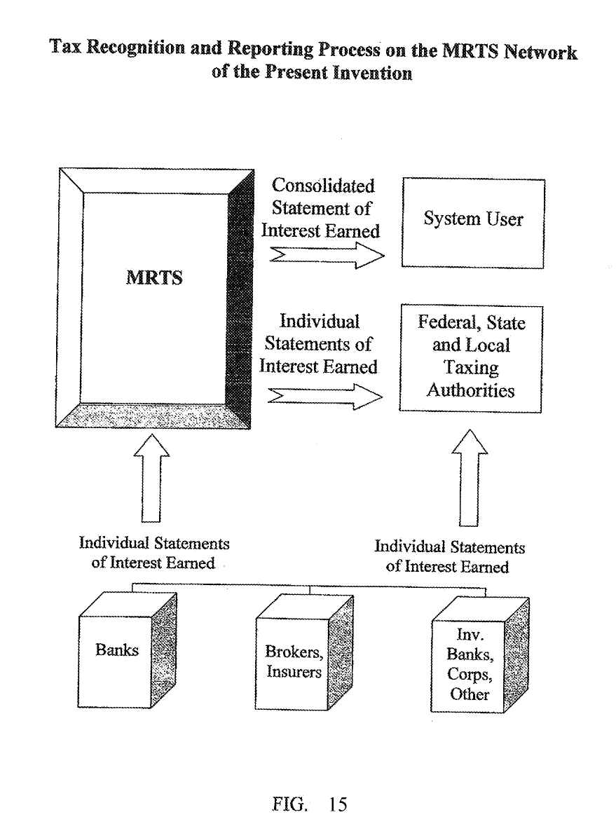

FIG. 15 is a schematic representation of the Tax Recognition and Reporting Process supported by the MRTS Network of the present invention, whereby the MRTS Network coordinates the collection and distribution of information pertaining to taxable interest earned by users of the MRTS Network.

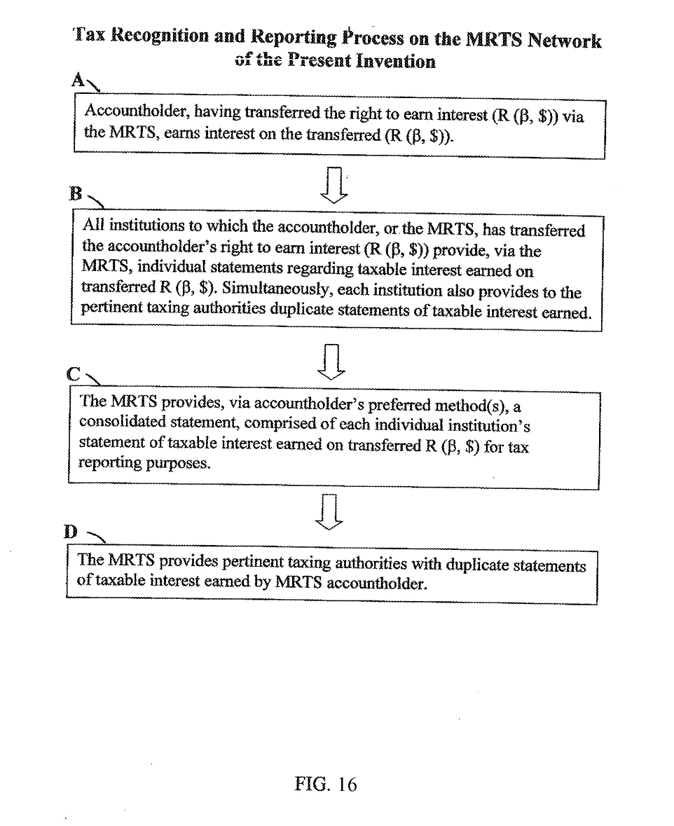

FIG. 16 represents the “Tax Recognition and Reporting Process within the MRTS” in the form of a flow chart. After having earned interest on transferred R (β, $), the individual participating institution(s), to which the MRTS accountholder's R (β, $) has been transferred, provide individual statements of taxable interest earned by the MRTS accountholder both to the relevant taxing authorities and to the MRTS Network which then provides an MRTS Network accountholder a consolidated statements of interest earned at various institution. As a confirmation of the taxable interest earned on transferred R (β, $) at each institution to which the MRTS accountholder transferred R (β, $), the MRTS also provides, on a periodic basis, the relevant taxing authorities with individual statements of taxable interest earned by the MRTS accountholder. The MRTS then provides the MRTS accountholder with a consolidated statement of taxable interest earned for income reporting purposes. The MRTS accountholder can also check, at any time, transactional logs maintained by the MRTS to ascertain taxable interest earned at any time.

Now referring to FIG. 16, a flow chart is shown depicting the various steps involved in the Tax Recognition and Reporting Process illustrated in FIG. 13. At Block A, the MRTS accountholder, having transferred the right to earn interest (R (β, $)) via the MRTS Network, earns interest on the transferred R (β, $ ). At Block B, all institutions, to which the MRTS Network accountholder (or the MRTS Network) has transferred the accountholder's R (β, $), provide, via the MRTS Network, individual statements regarding taxable interest earned on the accountholder's transferred R (β, $). Simultaneously, each institution also provides, to the pertinent taxing authorities, duplicate statements of taxable interest earned. At Block C, the MRTS Network provides, via the MRTS accountholder's preferred method(s), a consolidated tax statement comprised of each institution's statement of taxable interest earned on transferred R (β, $) for tax reporting purposes. At Block D, the MRTS Network provides all pertinent taxing authorities with duplicate statements of taxable interest earned by an MRTS Network accountholder.

Also, it is understood that the illustrative embodiments may be modified in a variety of ways which will become readily apparent to those skilled in the art of having the benefit of the novel teachings disclosed herein. All such modifications and variations of the illustrative embodiments thereof shall be deemed to be within the scope and spirit of the present invention as defined by the Claims to Invention appended hereto.

1-6. (canceled)

7. An Internet-based system for enabling a holder or owner of an amount of monetary value backing financial products in the financial marketplace, the freedom to transfer the monetary rights associated with said amount of monetary value so as to optimize the use of said amount of monetary value, said Internet-based system comprising:
an information infrastructure including communication, application and database servers configured within a communication network, coupling a computer network supporting a home financial institution;
wherein said home financial institution maintains a first account which holds a monetary amount for a first system user, and wherein said first system user is an owner or holder of said monetary amount;
wherein said home financial institution maintains a second account associated with a financial product for use by a second system user in the financial marketplace;
wherein said internet-based system is configured to recognize and account for an unbundled and individually transferable set of monetary rights associated with an amount of monetary value, said unbundled and individually transferable set of monetary rights (R (α. . . τ, $)) selected from the group consisting of: a monetary right to invest ((R (α, $)), a monetary right to lend (R (γ, $)), a monetary right to earn interest (R (β, $)), and a monetary right to gift (R (ι, $)), a monetary right to use as collateral (R (x, $)), a monetary right to hold money as a store of value (R (δ, $)), a monetary right to make purchases (R (ε, $)), and a monetary right to make payments (R (φ, $));
wherein said owner or holder of said amount of money transfers, via said Internet-based system, to said second account, a subset of monetary rights including the rights to make purchases and to make payments in demand transactions backed by a monetary value held at said first account, for use and exercise by the second system user in one or more demand transactions, while a non-transferred subset of said monetary rights associated with said monetary value, including the monetary right to earn interest (R (β, $)), remains at said first account serving as full, non-leveraged collateral for said transferred subset of monetary rights; and
wherein when said second system user exercises one or more of said transferred monetary rights to make purchases (R (ε, $)), and make payments (R (φ, $)), by executing a demand transaction on said second account for a purchase or payment amount, and upon said Internet-based system receiving notice that said second system user exercised one or more of said monetary rights to make purchases and make payments, said Internet-based system automatically reduces the monetary value remaining in said first account commensurate with the monetary value of the demand transaction associated with the exercise of said transferred monetary rights.

8. The Internet-based system of claim 7, wherein when said first system user exercises one or more of said non-transferred monetary rights within said home financial institution, and upon said Internet-based system receiving notice that said first system user exercised one or more of said non-transferred monetary rights, said Internet-based system automatically reduces the monetary value remaining in said first account commensurate with the monetary value of said exercised non-transferred monetary rights.

9. The Internet-based system of claim 8, wherein when said first system user exercises the non-transferred monetary right to invest ((R (α, $)) within said home financial institution, and upon said Internet-based system receiving notice that said first system user exercised said non-transferred monetary right to invest, said Internet-based system automatically reduces the monetary value remaining in said first account commensurate with the monetary value of said exercised non-transferred monetary right to invest.

10. The Internet-based system of claim 8, wherein when said first system user exercises said non-transferred monetary right to invest ((R (α, $)) and earns interest within said home financial institution, and upon said Internet-based system receiving notice that said first system user exercised said non-transferred monetary right to invest, said Internet-based system automatically (i) reduces the monetary value remaining in said first account commensurate with the monetary value of said exercised non-transferred monetary right to invest, and (ii) increases the monetary value remaining in said first account by the amount of interest earned.

11. The Internet-based system of claim 8, wherein when said first system user exercises the non-transferred monetary right to lend (R (γ, $)), within said home financial institution, and upon said Internet-based system receiving notice that said first system user exercised said non-transferred monetary right to lend, said Internet-based system automatically reduces the monetary value remaining in said first account commensurate with the monetary value of said exercised non-transferred monetary right to lend.

12. The Internet-based system of claim 11, wherein when said first system user exercises the non-transferred monetary right to lend (R (γ, $)) and earns interest within said home financial institution, and upon said Internet-based system receiving notice that said first system user exercised said non-transferred monetary right to lend, said Internet-based system automatically (i) reduces the monetary value remaining in said first account commensurate with the monetary value of said exercised non-transferred monetary right to lend, and (ii) increases the monetary value remaining in said first account by the amount of interest earned.

13. The Internet-based system of claim 8, wherein when said first system user exercises the non-transferred monetary right to gift (R (ι, $)) within said home financial institution, and upon said Internet-based system receiving notice that said first system user exercised said non-transferred monetary right to gift, said Internet-based system automatically reduces the monetary value remaining in said first account commensurate with the monetary value of said exercised non-transferred monetary right to gift.

14. The Internet-based system of claim 8, wherein when said first system user exercises the non-transferred monetary right to use as collateral (R (x, $)) within said home financial institution, and upon said Internet-based system receiving notice that said first system user exercised said non-transferred monetary right to use as collateral, said Internet-based system automatically reduces the monetary value remaining in said first account commensurate with the monetary value of said exercised non-transferred monetary right to use as collateral.

15. The Internet-based system of claim 8, wherein when said first system user exercises the non-transferred monetary right to hold money as a store of value (R (δ, $)) within said home financial institution, and upon said Internet-based system receiving notice that said first system user exercised said non-transferred monetary right to hold money as a store of value, said Internet-based system automatically reduces the monetary value remaining in said first account commensurate with the monetary value of said exercised non-transferred monetary right to hold money as a store of value (R (δ, $)).

16. The Internet-based system of claim 7, wherein said financial product is selected from the group including gift cards, debit cards, prepaid cards, stored value products, and other financial products.

17. . An Internet-based method for enabling a holder or owner of an amount of monetary value backing financial supporting financial products in the financial marketplace, the freedom to transfer the monetary rights associated with said amount of monetary value so as to optimize the use of said amount of monetary value, said network-enabled method comprising the steps of:
(a) providing an Internet-based system supported by an information infrastructure including communication, application and database servers configured within a communication network, coupling a computer network supporting a home financial institution;
(b) said home financial institution maintaining a first account which holds a monetary amount for a first system user, and wherein said first system user is an owner or holder of said monetary amount;
(c) said home financial institution maintaining a second account associated with a financial product for use by a second system user in the financial marketplace;
(d) said internet-based system being configured to recognize and account for an unbundled and individually transferable set of monetary rights associated with an amount of monetary value, said unbundled and individually transferable set of monetary rights (R (α. . . τ, $)) selected from the group consisting of a monetary right to invest ((R (α, $)), a monetary right to lend (R (γ, $)), a monetary right to earn interest (R (β, $)), and a monetary right to gift (R (ι, $)), a monetary right to use as collateral (R (x, $)), a monetary right to hold money as a store of value (R (δ, $)), a monetary right to make purchases (R (ε, $)), and a monetary right to make payments (R (φ, $));
(e) said owner or holder of said amount of money transferring, via said Internet-based system, to said second account, a subset of monetary rights associated with said monetary value, including the rights to make purchases and to make payments in demand transactions backed by a monetary value held at said first account, for use and exercise by the second system user in one or more demand transactions, while a non-transferred subset of said monetary rights associated with said monetary value, including the monetary right to earn interest (R (β, $)), remains at said first account serving as full, non-leveraged collateral for said transferred subset of monetary rights; and
(f) said second system user exercising one or more of said transferred monetary rights to make purchases (R (ε, $)) and make payments (R (φ, $)), by executing a demand transaction on said second account for a purchase or payment amount, and upon said Internet-based system receiving notice that said second system user exercised one or more of said monetary rights to make purchases and make payments, said Internet-based system automatically reducing the monetary value remaining in said first account commensurate with the monetary value of the demand transaction associated with the exercise of said transferred monetary rights.

18. The Internet-based method of claim 17, wherein when said first system user exercises one or more of said non-transferred monetary rights within said home financial institution, and upon said Internet-based system receiving notice that said first system user exercised one or more of said non-transferred monetary rights, said Internet-based system automatically reduces the monetary value remaining in said first account commensurate with the monetary value of said exercised non-transferred monetary rights.

19. The Internet-based method of claim 18, wherein when said first system user exercises the non-transferred monetary right to invest ((R (α, $)) within said home financial institution, and upon said Internet-based system receiving notice that said first system user exercised said non-transferred monetary right to invest, said Internet-based system automatically reduces the monetary value remaining in said first account commensurate with the monetary value of said exercised non-transferred monetary right to invest.

20. The Internet-based method of claim 19, wherein when said first system user exercises said non-transferred monetary right to invest ((R (α, $)) and earns interest within said home financial institution, and upon said Internet-based system receiving notice that said first system user exercised said non-transferred monetary right to invest, said Internet-based system automatically (i) reduces the monetary value remaining in said first account commensurate with the monetary value of said exercised non-transferred monetary right to invest, and (ii) increases the monetary value remaining in said first account by the amount of interest earned.

21. The Internet-based method of claim 18, wherein when said first system user exercises the non-transferred monetary right to lend (R (γ, $)), within said home financial institution, and upon said Internet-based system receiving notice that said first system user exercised said non-transferred monetary right to lend, said Internet-based system automatically reduces the monetary value remaining in said first account commensurate with the monetary value of said exercised non-transferred monetary right to lend.

22. The Internet-based method of claim 21, wherein when said first system user exercises the non-transferred monetary right to lend (R (γ, $)) and earns interest within said home financial institution, and upon said Internet-based system receiving notice that said first system user exercised said non-transferred monetary right to lend, said Internet-based system automatically (i) reduces the monetary value remaining in said first account commensurate with the monetary value of said exercised non-transferred monetary right to lend, and (ii) increases the monetary value remaining in said first account by the amount of interest earned.

23. The Internet-based method of claim 18, wherein when said first system user exercises the non-transferred monetary right to gift (R (ι, $)) within said home financial institution, and upon said Internet-based system receiving notice that said first system user exercised said non-transferred monetary right to gift, said Internet-based system automatically reduces the monetary value remaining in said first account commensurate with the monetary value of said exercised non-transferred monetary right to gift.

24. The Internet-based method of claim 18, wherein when said first system user exercises the non-transferred monetary right to use as collateral (R (x, $)) within said home financial institution, and upon said Internet-based system receiving notice that said first system user exercised said non-transferred monetary right to use as collateral, said Internet-based system automatically reduces the monetary value remaining in said first account commensurate with the monetary value of said exercised non-transferred monetary right to use as collateral.

25. The Internet-based method of claim 18, wherein when said first system user exercises the non-transferred monetary right to hold money as a store of value (R (δ, $)) within said home financial institution, and upon said Internet-based system receiving notice that said first system user exercised said non-transferred monetary right to hold money as a store of value, said Internet-based system automatically reduces the monetary value remaining in said first account commensurate with the monetary value of said exercised non-transferred monetary right to hold money as a store of value (R (δ, $)).

26. . The Internet-based method of claim 17, wherein said financial product is selected from the group including gift cards, debit cards, prepaid cards, stored value products, and other financial products.
